(19) United States
(12) Patent Application Publication
(10) Pub. No.: US 2024/0254807 A1
(43) Pub. Date: Aug. 1, 2024

(54) DEVICES, SYSTEMS, AND METHODS FOR SECURE ACCESS

(71) Applicant: JANUS INTERNATIONAL GROUP, LLC, Temple, GA (US)

(72) Inventors: Rajiv MANTENA, Salt Lake City, UT (US); Jacob GOSLING, Eagle Mountain, UT (US); Matthew Wayne BETTRIDGE, Saratoga Springs, UT (US); Christopher Lee NIELD, American Fork, UT (US); Jason FLINT, Highland, UT (US); Matt KUBIKOWSKI, South Jordan, UT (US)

(21) Appl. No.: 18/430,083

(22) Filed: Feb. 1, 2024

Related U.S. Application Data
(60) Provisional application No. 63/482,637, filed on Feb. 1, 2023.

(51) Int. Cl. E05B 47/00

(52) U.S. Cl. CPC E05B 47/0001; E05B 2047/0058

(57) ABSTRACT

An electronic lock assembly can include a latch for engagement with a catch assembly. The latch can be configured to be secured with a door and can include a latch housing and a hasp coupled with the latch housing. The catch assembly can be configured to be secured with a door frame. The hasp is movable relative to latch housing between an engaged position blocking against movement of the door and a disengaged position allowing movement of the door. The electronic lock assembly can include at least one electrical terminal that can communicate electricity in the engaged position of the hasp.

### CROSS-REFERENCE

This Non-provisional patent application claims the benefit of priority to U.S. provisional application No. 63/482,637, filed on Feb. 1, 2023, entitled “POWERED DOOR LOCK”, the contents of which are incorporated herein by reference in their entirety.

### TECHNICAL FIELD

The present disclosure generally relates to devices, systems, and methods for access security for a door within a self-storage facility, for example.

### BACKGROUND

Self-storage facilities rent storage space to tenants such as individuals and businesses. A self-storage facility may separate its storage space by unit. While a unit can be anything from lockers, containers, to even outdoor spaces, a typical unit often corresponds to an enclosed and climate-controlled room that is accessible via a lockable door. A self-storage facility may grant access to a given unit though various means, such as a physical key, a unique code to be input on a keypad, a digital key generated using tenant credentials, and the like.

Generally, a self-storage facility has numerous units. Some of the units in the self-storage facility may not be accessed by their tenant for extended periods of time. This can pose an issue for a tenant if the access means for the tenant's unit is powered by batteries with a limited life.

### SUMMARY

According to one aspect of the present disclosure, a secure access assembly may include a storage door assembly including a storage door and a door frame, the storage door arranged movable relative to the door frame between a closed position blocking access through the door frame and an open position allowing access through the door frame; a catch assembly for selective engagement to block opening of the storage door, the catch assembly including a catch receiver of the door frame, a catch housing configured for coupling with the door frame, and an electrical assembly for electrical engagement to communicate electrical power, the electrical assembly arranged within the catch housing, wherein the catch receiver includes a catch opening defined by the door frame for locking engagement; and an electronic lock assembly. The lock assembly may include a latch assembly configured for coupling with the storage door, the latch assembly including a latch housing and a hasp arranged at least partly within the latch housing, the hasp being movable relative to latch housing between an latched position extended from the latch housing to engage with the catch assembly to block against movement of the storage door out from the closed position and a unlatched position retracted relative to the latch housing to disengage with the catch assembly to allow movement of the storage door between the closed and open positions. In the latched position, the hasp may be configured for engagement within the catch receiver to establish locking engagement, and may be configured for electrical engagement with the electrical assembly for electrical communication. Locking engagement illustratively includes engagement of the hasp through an opening in the door frame to block against opening of the storage door, such as by contact with the edges of the opening when the door is attempted to be opened. In some embodiments, locking engagement may include engagement of the hasp with a hasp opening of the catch housing.

In some embodiments, the hasp and the electrical assembly of the catch assembly may each include at least one electrical terminal configured for engagement with one another for electrical communication. Electrical engagement between the electronic lock assembly and the electrical assembly may include configuration to provide electrical power to the electronic lock assembly coupled with the storage door. Electrical engagement between the electronic lock assembly and the electrical assembly may include configuration to provide electrical power to a battery storage system of the electronic lock assembly.

In some embodiments, electrical engagement between the electronic lock assembly and the electrical assembly may include configuration to communicate electrical signals. For example, electrical signals may include analog and/or digital communications. Electrical engagement between the electronic lock assembly and the electrical assembly may include configuration to communicate electrical power including Power over Ethernet with the electronic lock assembly.

In some embodiments, the catch assembly may include an adjustment assembly for adjustment of an installed position of the catch housing relative to the door frame in at least one direction. The catch housing may include a base coupled with a mount flange, the mount flange configured for securing with the door frame. The adjustment assembly may include complimentary toothed connection between the base and mount flange.

In some embodiments, the complementary toothed connection may be configured to provide complimentary coupling between the base and mount flange selectively between a number of fixed positions as the installed position along a first direction. The first direction may be arranged along a direction of passage through an access opening of the door frame through which a user can access when the storage door is open. The electrical assembly of the catch assembly may include a carriage assembly for selective engagement with the electronic lock assembly for electrical engagement.

In some embodiments, the carriage assembly may include at least one electrical terminal adapted for movement relative to the catch housing in at least one direction for selective engagement with the hasp for electrical engagement. The carriage assembly may include a terminal housing having the at least one electrical terminal mounted therein. The at least one electrical terminal of the terminal housing may be resiliently mounted within the terminal housing configured for resilient movement. Resilient movement may be along a longitudinal direction of the terminal housing to promote resilient engagement between the at least one electrical terminal of the carriage assembly and at least one electrical terminal of the hasp.

In some embodiments, the at least one electrical terminal may be mounted with a spring resiliently biasing the at least one electrical terminal outward from the terminal housing. The terminal housing may be supported within the catch housing by a terminal suspension allowing controlled relative movement of the terminal housing to accommodate compliant engagement within the hasp. The terminal suspension may include a least one resilient suspension member coupled between the terminal housing and a carriage of the carriage assembly mounted within the catch housing, to resiliently support the terminal housing within the catch assembly.

In some embodiments, the terminal housing may be arranged resiliently suspended within the catch housing for controlled relative movement to accommodate compliant engagement within the hasp. In a default position, the terminal housing may be arranged with the at least one terminal spaced apart laterally from the location of the hasp in the latched position. In some embodiments, a magnetic member may be arranged within at least one of the hasp and the terminal housing to magnetically encourage physical contact between the at least one electrical terminal of the carriage assembly and the at least one electrical terminal of the hasp. The magnetic member may be arranged to magnetically attract the terminal housing from the default position towards the hasp to close electrical connection in the latched positon of the hasp.

In some embodiments, the carriage assembly may include a carriage slidably arranged within the catch housing between a distal position away from the storage door frame and a proximal position proximate to the door frame. The carriage assembly may include a number of rails mounted within the catch housing. The carriage may be slidably mounted on the number of rails for sliding between the distal and proximal positions. The carriage assembly may include a biasing assembly arranged to bias the carriage towards a default carriage position. The default carriage position may be the proximal position.

In some embodiments, the biasing assembly may include a spring arranged between the catch housing and the carriage bias the carriage towards the default carriage position. The biasing assembly may include an arm extending between the carriage and the catch housing, the arm biased by the spring into a default arm position to encourage the carriage towards the default carriage position. In some embodiments, the storage door may be a rollup door. The lock opening may be configured to contact the hasp arranged in the latched position under movement of the storage door out from the closed position to block opening.

According to another aspect of the present disclosure a secure access lock assembly may include a catch assembly and an electronic lock assembly. The catch assembly may be for selective engagement across a storage door-door frame threshold. The catch assembly may include a catch housing, and an electrical assembly for electrical engagement for electrical communication. The electronic lock assembly may include a latch assembly including a latch housing and a hasp arranged at least partly within the latch housing, the hasp being movable relative to latch housing between an latched position and an unlatched position. The latched position may be extended from the latch housing to engage with the catch assembly. The hasp may be associated with blocking against storage door movement relative to the storage door-door frame threshold. The unlatched position may be retracted relative to the latch housing to disengage with the catch assembly. The unlatched position may be associated with allowing movement relative to the storage door-door frame threshold. In the latched position, the hasp may be configured for engagement within the catch housing of the catch assembly for electrical engagement between the electronic lock assembly and the electronic assembly for electrical communication.

Embodiments presented herein disclose a system and techniques for locking a door such as a door to a storage locker in a self-storage facility.

In accordance with another aspect of the present disclosure, an electronic lock may include a latch configured to be secured to a door. The latch may include a latch housing and a hasp coupled with the latch housing and movable relative to latch housing between an engaged position blocking against movement of the door and a disengaged position allowing movement of the door. The hasp may include a hasp body and at least one first electrical terminal coupled to a distal end of the hasp body.

In some embodiments, the electronic lock may further include a catch configured to engage the movable latch in the engaged position to block against movement of the door relative to the catch. The catch may be coupled with the door, and may include a catch housing and at least one second electrical terminal in communication with a main power source.

In some embodiments, the at least one first and second electrical terminals may be configured for contact with one another in the engaged position of the hasp to communicate electrical power from the main power source to a battery within the latch housing. The battery may be configured to supply power for a lock actuator arranged within the latch housing, and may be configured to drive a hasp lock between a locked position to block against movement of the hasp and an unlocked position to allow movement of the hasp.

In accordance with another aspect of the present disclosure, a secure access assembly may include a storage door assembly including a storage door and a door frame. The storage door may be arranged movable relative to the door frame between a closed position blocking access through the door frame and an open position allowing access through the door frame. The door frame may include a catch.

In some embodiments, the secure access assembly further includes an electronic lock assembly. The electronic lock may include a latch secured to the storage door. The latch may include a latch housing and a hasp coupled with the latch housing and movable relative to latch housing between a latched position engaged with the catch to block against movement of the door and an unlatched position disengaged with the catch to allow movement of the door. In some embodiments, the hasp and the catch may each include at least one electrical terminal configured for contact with one another in the engaged position of the hasp to communicate electrical power from a main power source to a battery within the latch housing.

### BRIEF DESCRIPTION OF THE DRAWINGS

FIG. 1 is a perspective view of an electronic lock including a latch that is mounted to a door and a catch that is mounted to a door frame adjacent the door and configured to engage with the latch to block against the door from moving relative to the door frame;

FIG. 2 is a perspective view showing a movable hasp included in the latch moved to an engaged position in contact with portions of the catch 18 and/or the door frame to block against movement of the door away from the door frame;

FIG. 3 is a perspective view showing the movable hasp in a disengaged position spaced apart from the catch and from the door frame so that the door is free to move relative to the door frame to allow passage through a doorway defined by the door frame;

FIG. 4 is a partial exploded assembly view showing that the electronic lock includes an battery-charging system having a first electrical terminal coupled to the movable hasp and a second electrical terminal coupled to the catch and configured to engage with the first electrical terminal in the engaged position to transfer electrical power from a main power source to an internal battery located within the latch;

FIG. 5 is an enlarged portion of FIG. 4 showing the first and second electrical terminals engaged with one another;

FIG. 6 is a perspective view of a front side of the latch;

FIG. 7 is a perspective view of a rear side of the latch;

FIG. 8 is an elevation view of a secure access assembly including a storage door and door frame, and a secure access lock assembly including an electronic lock assembly mounted on the storage door and a catch assembly mounted on the door frame, according to disclosed embodiments within the present disclosure;

FIG. 9 is a perspective view of the electronic lock assembly of the secure access assembly of FIG. 8 with a hasp thereof in a latched position for engagement with the door frame for locking and with the catch assembly for electrical engagement, according to disclosed embodiments within the present disclosure;

FIG. 10 is a perspective view of the electronic lock assembly of FIG. 9 showing the hasp in an unlatched position for disengagement engagement with the door frame and with the catch assembly, according to disclosed embodiments within the present disclosure;

FIG. 11 is an exploded perspective view of the electronic lock assembly of FIGS. 8-10, showing various components, according to disclosed embodiments within the present disclosure;

FIG. 12 is an elevation view of a portion of the electronic lock assembly of FIGS. 9-11 to illustrate a locking assembly thereof arranged in a locked position, according to disclosed embodiments within the present disclosure;

FIG. 13 is an elevation view of the portion of the electronic lock assembly of FIG. 12 illustrating the locking assembly thereof arranged in an unlocked position, according to disclosed embodiments within the present disclosure;

FIG. 14 is an exploded perspective view of the catch assembly of the secure access assembly of FIG. 8, showing that the catch assembly includes a catch housing for housing an electrical assembly and a mount flange for coupling with the door frame, according to disclosed embodiments within the present disclosure;

FIG. 15 is a perspective view of the catch assembly of FIGS. 8 and 14 showing the catch housing and mount flange coupled together, according to disclosed embodiments within the present disclosure;

FIG. 16 is a perspective view of the catch assembly of FIGS. 8 and 14 showing the catch housing having the mount flange omitted to illustrate the electrical assembly which includes a carriage assembly and terminal housing, according to disclosed embodiments within the present disclosure;

FIG. 17 is a top plan view of a portion of a horizontal cross-section of the secure access assembly of FIG. 8 showing that an adjustment assembly includes a toothed connection, according to disclosed embodiments within the present disclosure;

FIG. 18 is a bottom plan view of a portion of a horizontal cross-section of the secure access assembly of FIG. 8, similar to FIG. 17, showing that the adjustment assembly includes the toothed connection, according to disclosed embodiments within the present disclosure;

FIG. 19 is a side elevation view of the catch assembly of FIG. 16 showing the catch housing having the mount flange omitted, and illustrating that terminal housing has a default position spaced apart from an exemplary positon of the hasp of the electronic lock assembly, according to disclosed embodiments within the present disclosure;

FIG. 20 is a side elevation view of the catch assembly of FIG. 16, similar to FIG. 19, showing the catch housing having the mount flange omitted, and illustrating that terminal housing has an engaged position relative to the exemplary positon of the hasp of the electronic lock assembly, and illustrating that a terminal suspension permits limited resilient movement of the terminal housing, according to disclosed embodiments within the present disclosure;

FIG. 21 is a perspective view of a horizontal cross section of the secure access assembly of FIG. 8 showing physical contact between the hasp and the terminal housing for electrical engagement, and showing that magnets provide magnetic attraction between the hasp and the terminal housing, according to disclosed embodiments within the present disclosure;

FIG. 22 is a perspective view of a vertical cross section of the secure access assembly of FIG. 8 showing physical contact between the hasp and the terminal housing for electrical engagement, and showing that the electrical terminals of the terminal housing include resilient contacts, according to disclosed embodiments within the present disclosure;

FIG. 23 is a diagrammatic view of electrical components of the secure access assembly of FIG. 8, according to disclosed embodiments within the present disclosure.

### DETAILED DESCRIPTION

Embodiments presented herein disclose a system and techniques for identifying a location of a unit within a facility, such as a self-storage facility. More particularly, embodiments provide a networked system of devices stored in, on, or around each unit of the self-storage facility.

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

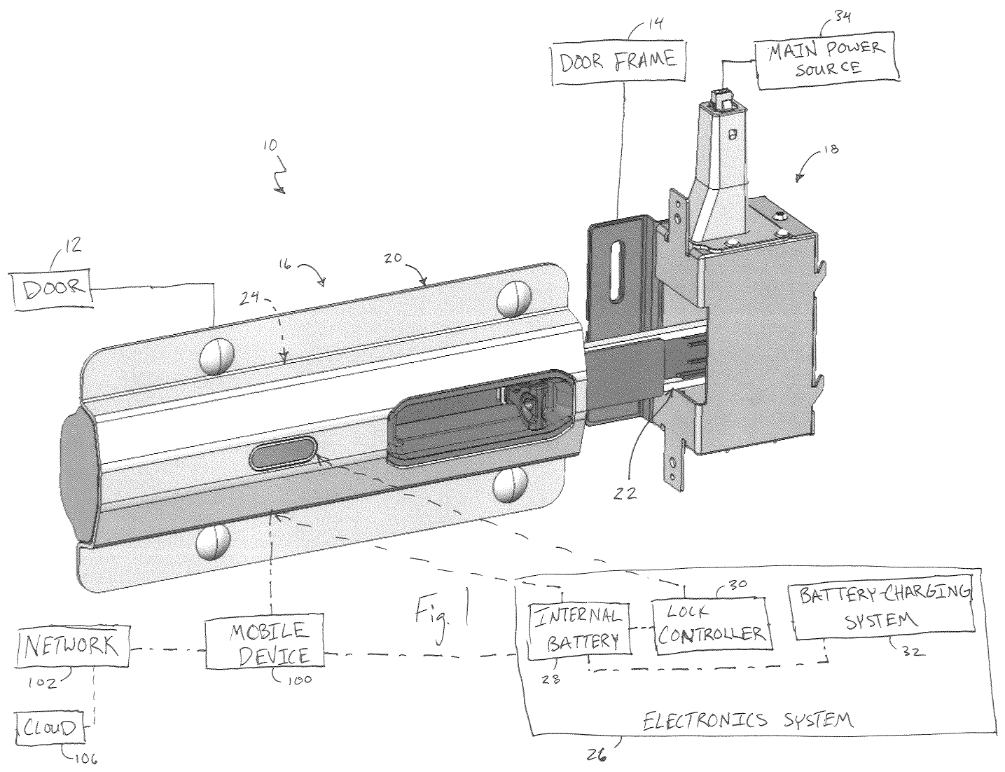

An electronic lock 10 is mounted to a door 12 and is configured to block against movement of the door 12 when the door 12 is in a closed position blocking against passage through a door frame 14 as shown in FIG. 1. The door 12 is illustratively embodied as a roll-up door, for example, for a secure storage room, but in some embodiments, may include any suitable door for secure access. The electronic lock 10 may be controlled using a mobile device 100 that communicates with the electronic lock 10 over a network 102. The mobile device 100 can be used by a user to input commands to lock and/or unlock the electronic lock 10, for example.

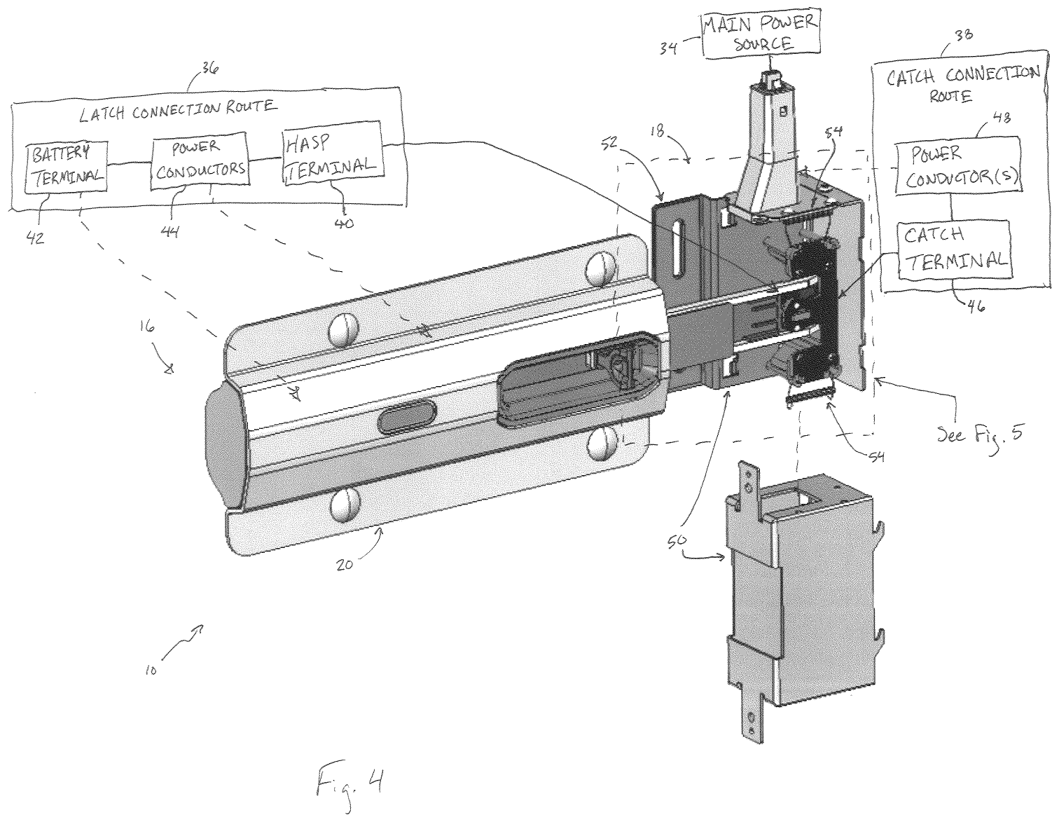

The electronic lock 10 includes a latch 16 coupled with the door 12 and a catch 18 coupled with the door frame 14 as shown in FIG. 1. The latch 16 is movable between a locked configuration, as shown in FIG. 1, and an unlocked configuration, as shown in FIG. 3. In the locked configuration, the latch 16 engages the catch 18 and is configured to block against movement of the door 12 relative to the door frame 14. In the unlocked configuration, the latch is disengaged from the catch 18 and the door 12 is free to move relative to the door frame 14 to allow passage through the door frame 14.

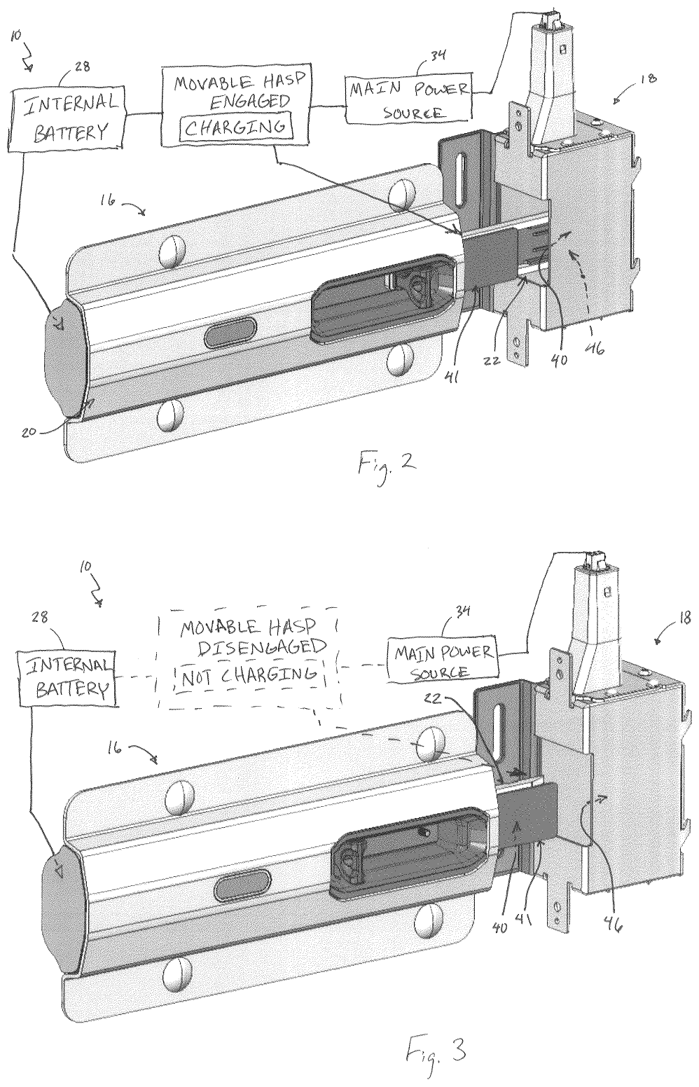

The latch 16 includes a latch housing 20 is fixed to the door for movement therewith, a movable hasp 22 coupled to the latch housing 20, and a hasp lock 24 as show in FIGS. 1 and 2. The movable hasp 22 is arranged to lie at least partially within an interior space defined by portions of the latch housing 20. The movable hasp 22 is slidable relative to the latch housing 20 between an engaged position contacting the catch 18 to establish the locked configuration and a disengaged position spaced apart from the catch 18 to establish the unlocked configuration. In the engaged position, the movable hasp 22 engages portions of the catch 18 and/or the door frame 14 and blocks against the door 12 from opening. In the disengaged position, the door 12 is free to move relative to the door frame 14 to allow passage through the door frame 14. The hasp lock 24 is also located within the interior space defined by the latch housing 20 and is configured to selectively engage with the movable hasp 22 to lock the movable hasp in the engaged position and block against unauthorized opening of the door 12.

In the illustrative embodiment, the electronic lock 10 further includes an electronics system 26 configured to control locking and/or unlocking of the electronic lock 10 as shown in FIGS. 1 and 2. The electronics system 26 includes an internal battery 28, a lock controller 30 powered by the internal battery 28, and a battery-charging system 32 configured to recharge the internal battery 28. The internal battery 28 is located within the interior space defined by the latch housing 20. The lock controller 30 is configured to receive inputs from the mobile device 100 to control locking and/or unlocking of the hasp lock 24. The battery-charging system 32 interconnects the internal battery 28 to a main power source 34 when the movable hasp 22 is in the engaged position to recharge the internal battery 28 and increase the usable life of the electronic lock 10 with the internal battery 28. The battery-charging system 32 may be formed as a battery management system for regulating charging of the battery.

The battery-charging system 32 includes a latch connection route 36 and a catch connection route 38. The latch connection route 36 interconnects the internal battery 28 with the catch connection route 38 when the latch 16 is in the engaged position. The catch connection route 38 interconnects the main power source 34 with the latch connection route 36 when the latch 16 is in the engaged position.

The latch connection route 36 includes a hasp terminal 40 coupled to the movable hasp 22, a battery terminal 42 coupled to the internal battery 28, and a plurality of power conductors 44 extending between and interconnecting the hasp terminal 40 and the battery terminal 42. The hasp terminal 40 is coupled to a distal end of the movable hasp 22 and is configured to contact the catch connection route 38 when the movable hasp 22 is in the engaged position. The battery terminal 42 is in contact with the internal battery 28 whenever the internal battery 28 is fully installed in the electronic lock 10. The plurality of power conductors 44 establish a continuous circuit from the hasp terminal 40, to the battery terminal 42, and back to the hasp terminal 40. The latch 16 further includes a terminal shield 41 that extends toward the catch 18 and is configured to overlie the hasp terminal 40 in the disengaged position to block against interference with the hasp terminal 40.

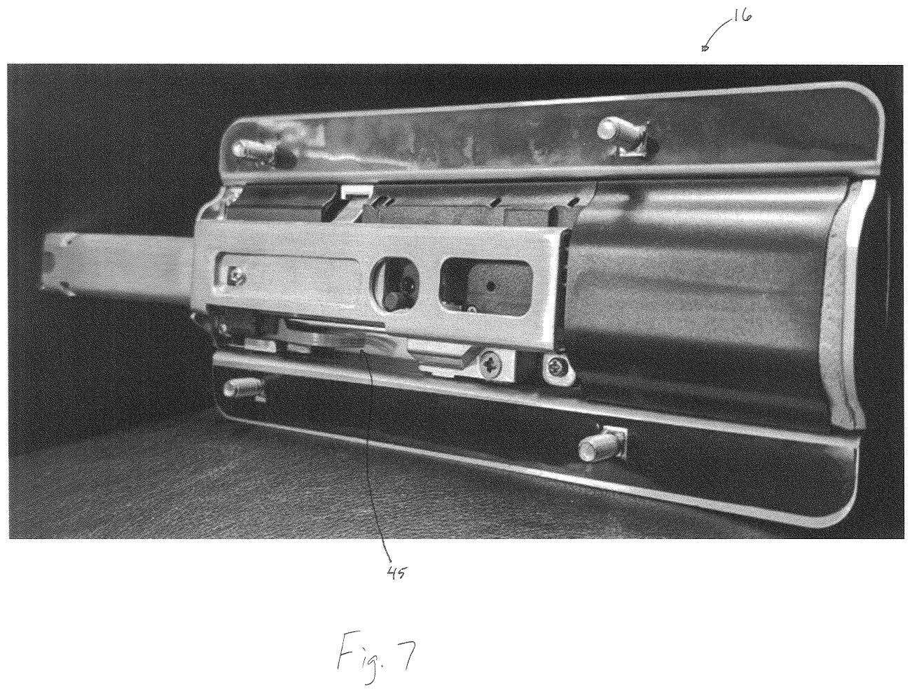

The plurality of power conductors 44 includes at least one flexible conductor 45 that has a fixed end that remains stationary relative to the rest of the latch 16 and a movable end coupled to the movable hasp 22 for movement therewith as shown in FIG. 7. A distance between the stationary end and the movable end changes as the movable hasp 22 moves from the engaged position to the disengaged position. In the illustrative embodiment, the flexible conductor is formed into a u-shaped or j-shaped loop which has a longer arc length in the engaged position compared to the disengaged position. Thus, the distance between the stationary and movable ends increases as the movable hasp 22 changes from the engaged position to the disengaged position.

The catch connection route 38 includes a catch terminal 46 and at least one power conductor 48. The catch terminal 46 is configured to contact the hasp terminal 40 when the movable hasp 22 is in the engaged position. The at least one power conductor 48 interconnects the main power source 34 and the catch terminal 46. When the movable hasp 22 is in the engaged position, a continuous circuit is established by the latch connection route 36 and the catch connection route 38 to circulate electrical energy from the main power source 34 to the internal battery 28 and to recharge the internal battery 28. It should be appreciated that both the hasp terminal 40 and the catch terminal 46 have positive and negative connection points to connect with each other and establish a circuit when the hasp terminal 40 is engaged with the catch terminal 46. In some embodiments, the electronics may be grounded to the door itself. The electronics in the door lock 10 are reverse polarity protected so that electrical current through the routes 36, 38 can be reversed and still charge the battery 28.

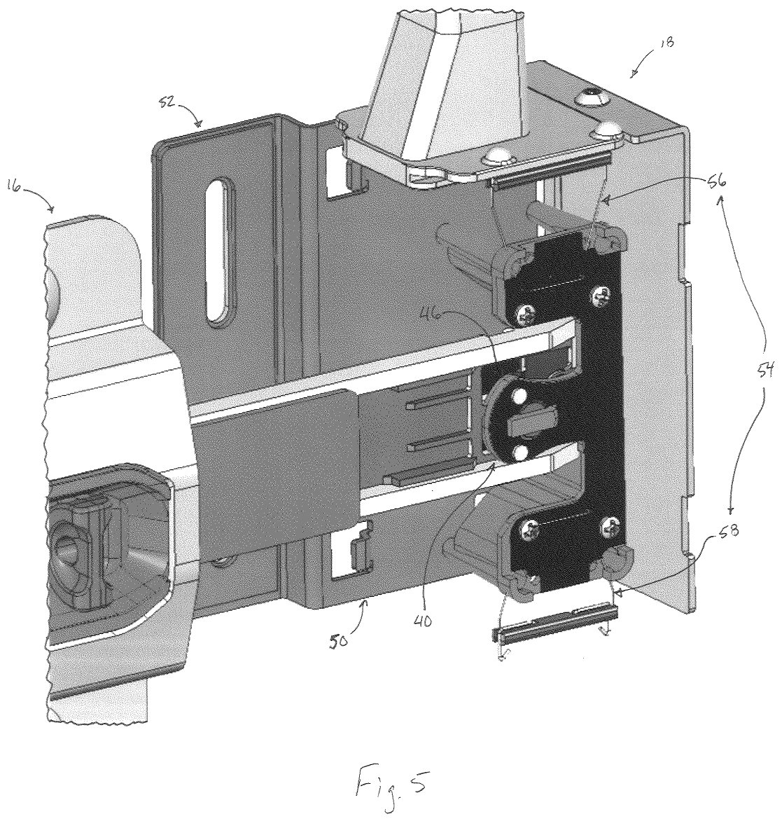

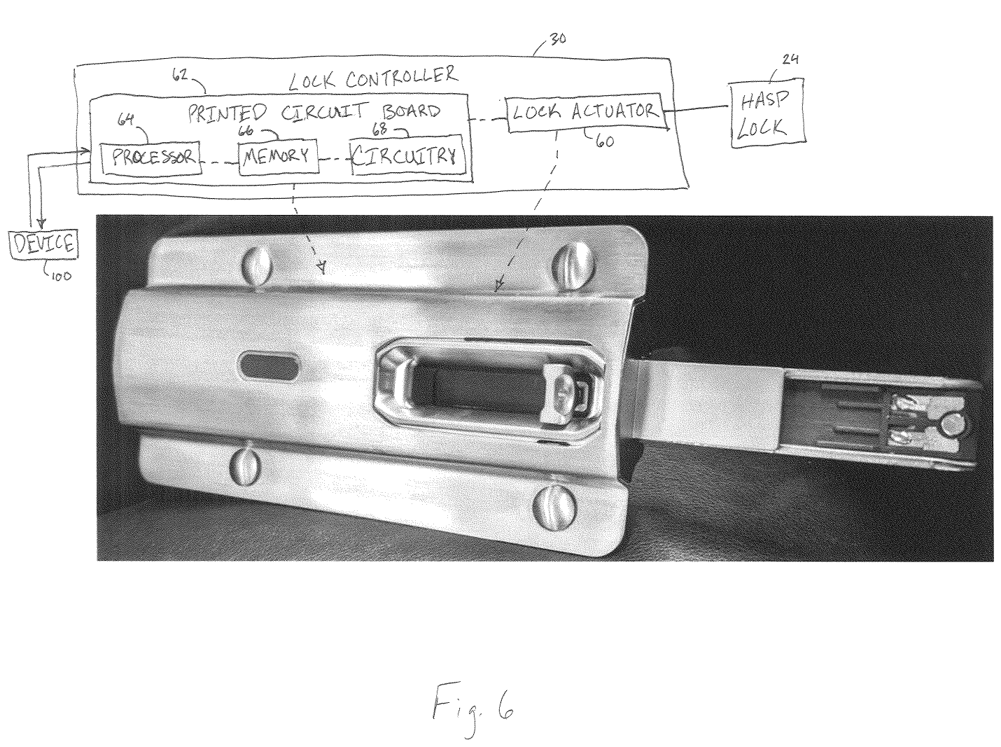

The catch 18 includes a catch housing 50, a catch mount 52 coupled to the catch housing 50, and a terminal suspension 54 as shown in FIGS. 4 and 5. The catch housing 50 is formed to include an interior space which houses the catch terminal 46. The catch mount 52 is coupled to exterior surfaces of the catch housing 50 and is formed to include one or more mount openings 56 that receive fasteners (not shown) to attach the catch 18 to the door frame 14 in a fixed position. The terminal suspension 54 is configured to interconnect the catch terminal 46 and the catch housing 50 to space the catch terminal 46 from the rest of the catch 18.

When the movable hasp 22 is in the engaged position, the door 12 may still be able to move slightly relative to the door frame 14 and the catch housing 50 in some embodiments. The terminal suspension 54 allows slight movements of the catch terminal 46 relative to the catch housing 50 as the movable hasp 22 moves with the door 12 relative to the door frame 14. In the illustrative embodiment, the terminal suspension 54 includes a pair of wire hangers 56, 58 coupled to opposite ends of the catch terminal 46.

The mobile device 100 may be embodied as any physical computing device accessible by a user (e.g., a tenant user, an operator or employee of the storage facility system, a system administrator, etc.) having wireless communication functionality, such as a smart phone, smart tablet, laptop device, etc. The mobile device 100 may be owned by a tenant user, a device located on-site at the underlying self-storage facility, a device located remotely from the self-storage facility (e.g., at a management console associated with the self-storage facility), and so on. Illustratively, the mobile device 100 also includes an app. In an embodiment, the app allows a tenant user to communicate with a cloud service 106 also coupled to the network 102, authenticate credentials associated with the user, identify one or more electronic locks registered to the user, and lock or unlock the electronic locks through a graphical user interface presented on a display of the mobile device 100. As further described herein, the app allows the user to interface with the lock controller 30 of the electronic lock 10.

The lock controller 30 illustratively includes a lock actuator 60 and a circuit board 62 having a processor 64, a memory storage device 66, and communication circuitry 68. The lock actuator 60 is configured to move relative to the latch housing 20 to actuate the hasp lock 24 to move the hasp lock 24 from the locked position to the unlocked position and/or from the unlocked position to the locked position. The processor 64 is configured to output a command signal to the lock actuator 60 in response to an input from a user from the mobile device 100, for example. The memory storage device 66 stores instructions that, when executed by the processor 64, cause communications with the lock actuator 60 to actuate the hasp lock 24 upon receipt of the command signal from the microprocessor 64. The communication circuitry 68 interconnects components of the circuit board 62 and the lock actuator 60 and can include wireless means, such as an antenna and/or transceiver, for communicating with the mobile device 100. The communication circuitry 68 is configured to communicate user inputs and/or communications signals between components of the circuit board 62 and the lock actuator 60. The communication circuitry 68 may communicate with the mobile device, other devices, and/or networks using Bluetooth, Bluetooth Low Energy (BLE), WiFi, Zigbee, Ultra wideband (UWB), Wirepas or other mesh networking, or any other suitable wireless means. In some embodiments, the signals are encrypted.

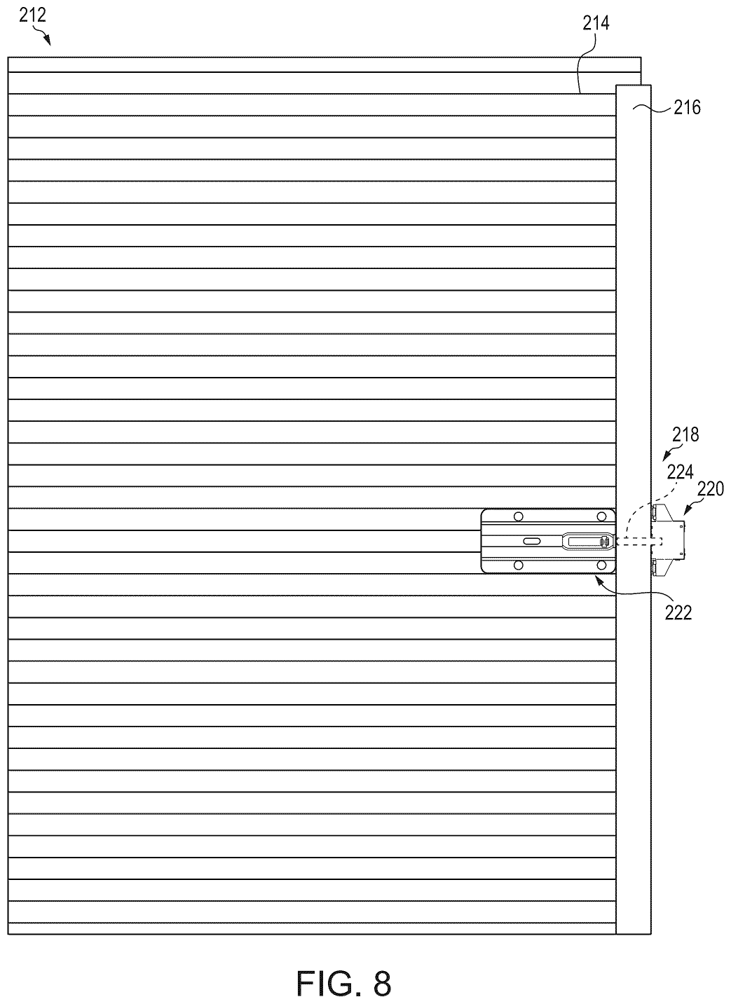

Referring now to FIG. 8, according to another aspect of the present disclosure, an electronic lock assembly is shown as a part of a secure access assembly 212. The secure access assembly 212 includes a storage door 214 and door frame 216 supporting the storage door. The storage door 214 is illustratively embodied as a corrugated rollup door, but in some embodiments, may be any suitable manner of door with complimentary door frame. The secure access assembly 212 includes a locking assembly 218 including a catch assembly 220 and electronic lock assembly 222 which can be selectively engaged together in electrical engagement. The locking assembly 218 is illustratively similar to the electronic lock 10 and catch 18, and disclosure of electronic lock 10 and catch 18 applies equally to locking assembly 218, as modified by the specific disclosure of locking assembly 218.

In the illustrative embodiment, the electronic lock assembly 222 is embodied as a sliding lock, having a hasp 224 slidable between engaged (latched) and disengaged (unlatched) positions as discussed in additional detail herein. In the engaged position of the hasp 224, electrical engagement can be established between the catch assembly 220 and the electronic lock assembly 222. Such electrical engagement can provide electrical power to the electronic lock assembly 222, for example, to operate, charge, and/or communicate across the door-door frame threshold, while reducing the complexity of the connections and installation requirements, among other things. In the illustrative embodied as suggested in FIG. 8, the hasp 224 is shown in the engaged position, penetrating through a lock opening in the door frame 216 to restrict movement of the storage door, and engaged with the catch assembly 220 for electrical engagement. In some embodiments, the lock opening defined in the door frame may be considered part of the catch assembly, for example as a catch receiver for locking engagement.

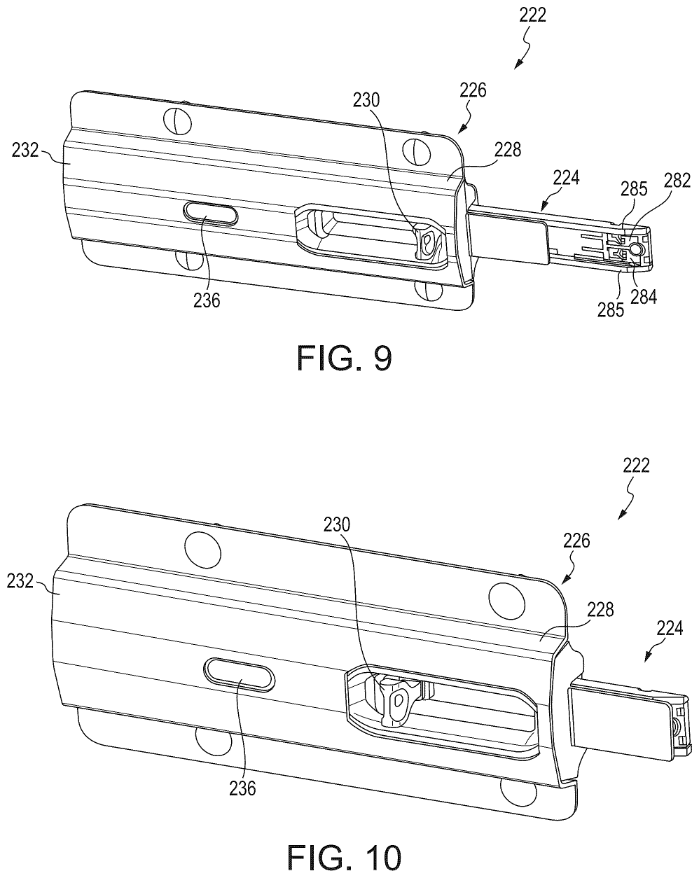

Referring to FIGS. 9 & 10, the electronic lock assembly 222 illustratively includes a latch assembly 226 configured for coupling with the storage door 214 as suggested in FIG. 8. The latch assembly 226 includes a latch housing 228 and the hasp 224. The hasp 224 is illustratively formed as an elongated bar arranged at least partly within the latch housing 228. The hasp 224 is illustratively mounted within the latch housing 228, movable between an extended, latch position as suggested in FIG. 9, extending out from the latch housing 228 for (selective) engagement with the door frame 216 to block against opening of the storage door and for (selective) engagement with the catch assembly 220 for electrical engagement; and a retracted, unlatched position as shown in FIG. 10, retracted with the latch housing for disengaging with the door frame 216 to allow the storage door 214 to be moved from the closed position towards the open position and with the catch assembly 220 to disconnect electrical engagement.

In the illustrative embodiment, the electronic lock assembly 222 includes electronic features, but is manually operated between the latch and unlatched positions of the hasp 224. Accordingly, the electronic lock assembly 222 includes a handle 230 illustratively extending perpendicularly to the longitudinal extent of the hasp 224 (and illustratively laterally with respect to the sliding movement of the hasp 224) for the user to grasp the handle 230 to slide the hasp 224. Electronics may be applied in governing locking operation to selectively permit (or deny) sliding operation of the hasp 224 between latched and unlatched positions, to monitor and/or communicate status information and/or other data concerning operation and/or surroundings. In some embodiments, electronic operation of the hasp 224 may be applied.

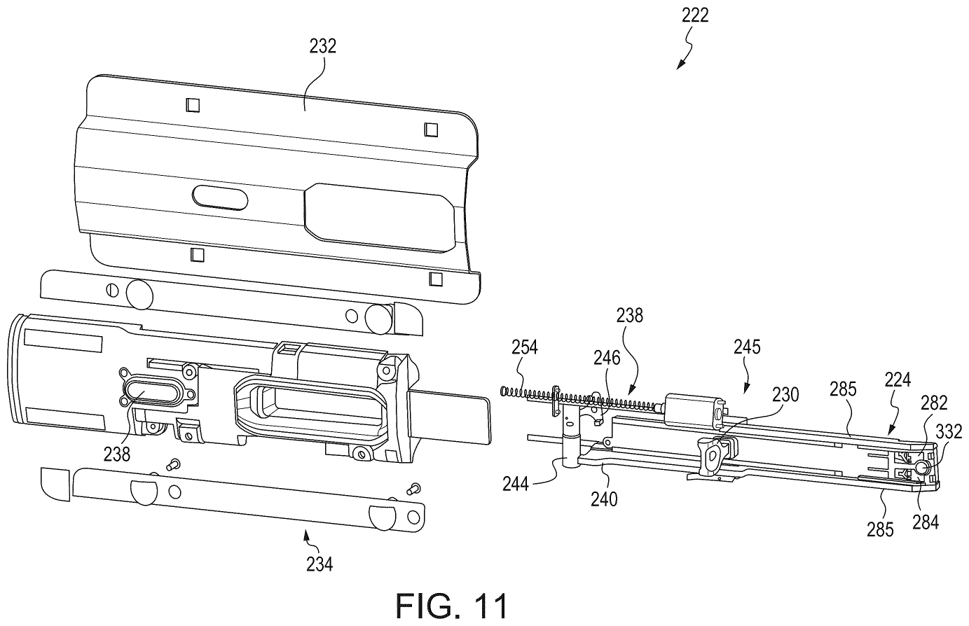

Referring to FIG. 11, the electronic lock assembly 222 is shown in partial exploded view for descriptive ease. The latch housing 228 illustratively includes covering 232 and a frame 234. The frame 234 is coupled within the covering 232 to support lock operations, including movement of the hasp 224. In the illustrative embodiment, the covering 232 is defined as a facial covering which is coupled, e.g., by bolting, to the front surface of the storage door to defined a cavity within which the frame and other components are enclosed. An interface button 236 is formed on the frame 234 for user engagement through a complimentary opening of the covering 232.

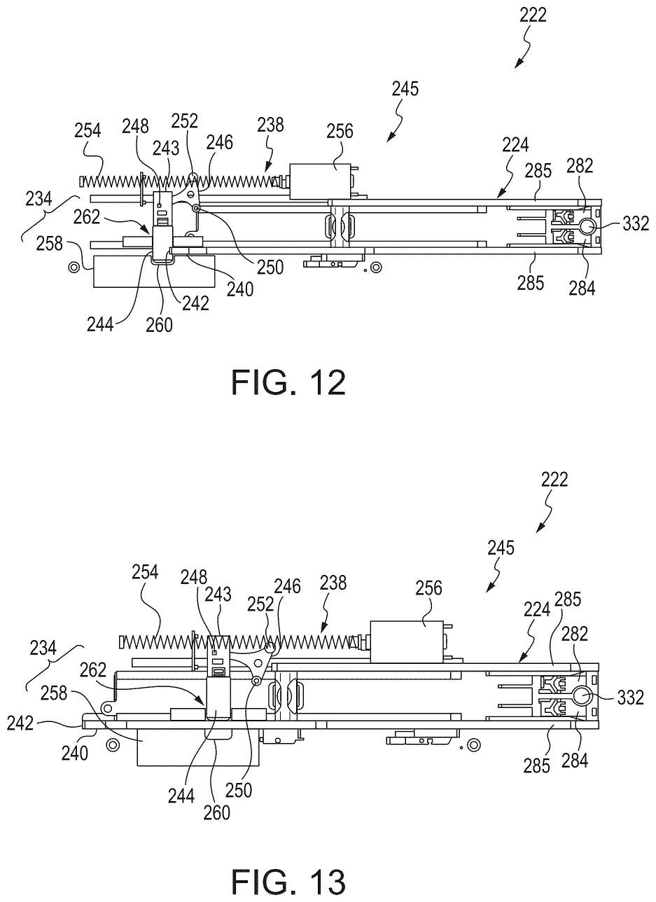

Locking operations are discussed with respect to FIGS. 12 & 13, showing internal views of locking assembly 238. The electronic lock assembly 222 includes the locking assembly 238 which can be operated to selectively block against movement of the hasp 224 out from the extended, latched position. In the illustrative embodiment, the hasp 224 includes a striker 240 embodied as a flanged portion. The striker 240 includes a contact surface 242 which can engage with a stopper 244 to block movement of the hasp 224 as suggested in FIG. 12.

The stopper 244 is illustratively embodied as a pin with connected plate 243, the stopper 244 being supported by the frame 234 for selective movement between a block position (as suggested in FIG. 12) to engage with the hasp 224 to block movement of the hasp 224 out from the latched position, and a release position (as suggested in FIG. 13) out of engagement with the hasp 224 to allow the hasp 224 to be moved out from the latched position towards the unlatched position.

As suggested in FIGS. 12 & 13, the stopper 244 is supported for movement within a slot 262 of the frame 234. The frame 234 includes a receiver 258 having a receiver opening 260 that is coaxial with the slot 262 to receive the stopper 244 in the block position. In the block position, the stopper 244 extends out from the slot 262 and is received within a receiver opening 260 of the receiver 258 (FIG. 12); and in the release position, the stopper 244 is withdrawn out from the receiver opening 260 (FIG. 13). When in the block position, the stopper 244 can engage with each of the portion of the frame 234 defining the slot 262, the hasp 224, and the receiver 258 to provide a two shear plane arrangement to assist locking, one shear plane relative to the slot 262 and another shear plane relative to the receiver opening 260. This multiple shear plane arrangement can decrease the stress and/or strain on the connection, permitting less costly, smaller, and/or less advanced materials for one or more of the stopper 244, hasp, frame, and/or related parts. The stopper 244 is illustratively coupled with an actuation system 245 for governing operation.

The actuation system 245 illustratively includes a lever 246 coupled with the stopper 244 to impose linear motion onto the stopper 244 between block and release positions. The lever 246 and stopper 244 are connected via yolk connection at a distal arm 248 of the lever 246 and the plate 243 of the stopper 244. In the illustrative embodiment, the lever 246 articulates in pivoting motion about a stationary pivot point 250, defined at another distal arm. The lever 246 articulates between an engage position corresponding with the block position of the stopper 242 and a disengage position away from the striker 240 corresponding with the release position of the stopper 242. The lever 246 receives force for articulation at still another distal arm 252.

The actuation system 245 includes a resilient member 254 embodied as a spring. The resilient member 254 illustratively extends between an actuator 256 and the lever 246 to resiliently transfer force. The actuator 256 is embodied as a rotary actuator for selective rotation of the resilient member 254 to drive the lever 246 for articulation by resilient force. The resilient member 254 is engaged with the distal arm 252 of the lever 246 by threading of the ball end of the distal arm 252 within the coils of the spring such that upon rotation of the actuator 256 (e.g., driving leftward in FIGS. 12 & 13) compression is applied to the resilient member 254, and corresponding resilient linear force to the distal arm 252 imposing articulation of the lever 246 about the pivot 250 (counterclockwise in the orientation as shown in FIGS. 12 & 13) to correspondingly encourage the stopper 244 into the block position. Reverse rotation of the actuator 256 can resiliently articulate the lever 246 to correspondingly encourage the stopper 244 out from the block position. In some embodiments, the actuator 256 may be formed as a linear actuator to applying linear motion to the resilient member 254 to selectively articulate the lever 246.

If the hasp 224 is arranged out of the latched position when the actuator 256 is operated to extend for locking, the stopper 244 may not be able to undertake the block position due to interference. Consequently, the resilient member 254 can remain charged (illustratively compressed) to release its stored energy once the hasp 224 is moved into the latched position, permitting the stopper 244 into the block position. From the block position of the stopper 244, the actuator 256 has been operated to extend for locking, but can be operated to retract for unlocking. Rotating (reverse) the actuator 256 applies a withdraw force to the resilient member 254, and corresponding resilient linear force to the distal arm 252 imposing articulation of the lever 246 about the pivot 250 (clockwise in the orientation as shown in FIGS. 12 & 13) to correspondingly encourage the stopper 244 out from the block position towards the release position. The interposition of resilient member 254 between thee actuator 256 and stopper 244 can permit the actuation system 245 to provide a default encouragement into a locked state such that when the hasp 224 is moved into the latched position, the resilient member 254 is already applying force to encourage the stopper into the block position.

Still referring to FIGS. 12 & 13, the hasp 224 includes a pair of electrical terminals 282, 284 for electrical engagement with an electrical assembly of the catch assembly 220 for electrical communication. In the illustrative embodiment, the terminals 282, 284 are embodied as electrical contact pads for engagement with corresponding terminals to have electrical engagement for electrical communication of power and/or data. In the illustrative embodiment, the terminals 282, 284 represent positive and negative terminals, providing complete electrical circuit between the catch assembly 220 and electronic lock assembly 222 across the door frame-storage door threshold, although in some embodiments, the electric circuit may be grounded on the storage door and thus, may only require a positive terminal across the threshold. In some embodiments, additional terminals may be provided, for example, for Ethernet connections which may have four pairs of wires or more. The terminals 282, 284 are illustratively arranged on a lateral face of the hasp 224 partially enclosed by sidewalls 285 which project perpendicularly from the face and which include chamfering towards a distal end of the hasp 224 to encourage smooth engagement across the door frame and with the catch assembly 220.

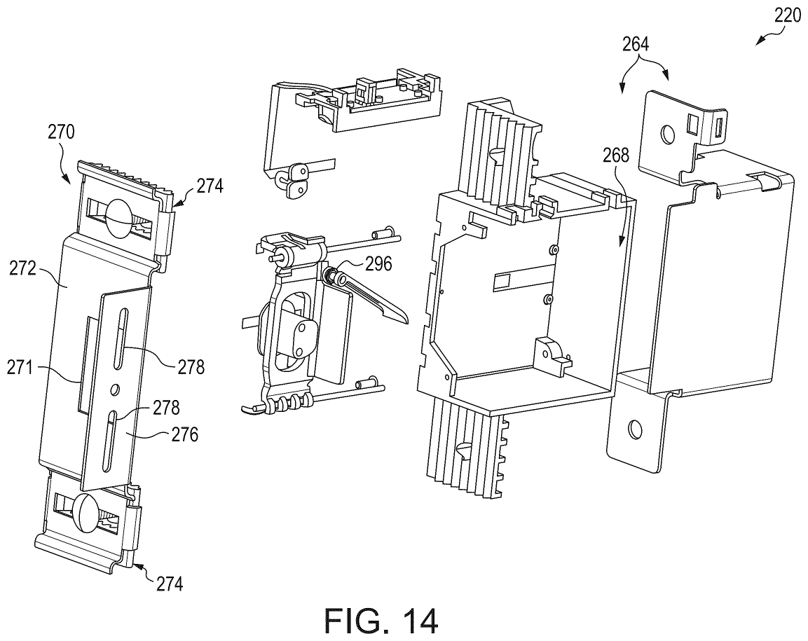

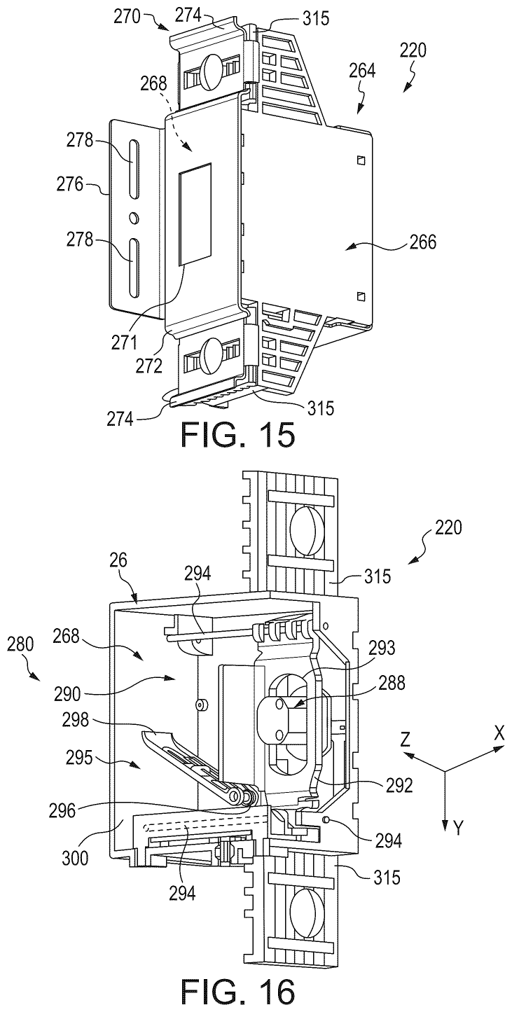

Referring now to FIGS. 14, 15, & 16, the catch assembly 220 illustratively includes a catch housing 264 configured for coupling with the door frame 216 for engagement with the hasp 224. The catch housing 264 includes a base 266 defining a body of the catch housing having internal cavity 268 for housing components including those of the electrical assembly as discussed in additional herein, and a mount flange 270 coupled with the base 266 and configured for coupling with the door frame 216.

The mount flange 270 illustratively includes a tongue 272 that defines a hasp opening 271 for receiving penetration of the hasp 224 into the internal cavity 268 of the base 266. The mount flange 270 includes connection wings 274 extending from opposite ends of the tongue 272 for connection with the housing 264 such that the tongue 272 partly encloses the cavity 268. The mount flange 270 includes an arm 276 extending from the tongue 272 on a side thereof adjacent to the wings 274.

The arm 276 is illustratively define as a plate oriented perpendicularly relative to the tongue 272 for coupling with the door frame 216. The arm 276 illustratively defines a number of fastener slots 278 for receiving fasteners therethrough for coupling with the housing 264. The slots 278 are defined with parallel elongation to permit fasteners, such as bolts or screws, to be selectively oriented along the slots 278 allowing installation adjustment of the entire catch assembly 220 along the direction of elongation (illustratively, the vertical direction in the orientation of FIGS. 14 & 15).

Referring to FIG. 16, the catch assembly 220 is shown having the mount flange 270 and the covering potion of the housing removed to illustrate internals. Within the housing 264, the catch assembly 220 illustratively includes an electrical assembly 280 arranged for electrical engagement with the hasp 224 for electrical communication as discussed in additional detail herein. The electrical assembly 280 includes a terminal housing 288 providing electrical terminals for electrical communication with the hasp 224.

The electrical assembly 280 provides a resilient interface for electrical engagement with the hasp 224 to allow electrical connection with the electronic lock assembly while accommodating variability in the position of the hasp 224. For example, the interface between storage doors and door frame can enjoy considerably large tolerances, whether from the storage door variation, the door frame variation, other variation such as building variations, or more than one variation. These variations can allow the storage door to have a wide range of positions in each of three dimensions in the closed state relative to the door frame. Thus, even a properly installed storage door make take on a variety of different positions each time it is closed, and a respective hasp placed in the engaged (extended) position for locking and electrical communication can take on many variety of positions. Additionally, different installations may define different relative positions between the hasp and the electrical assembly. Accordingly, resilience and/or flexibility to establish confident electrical engagement despite variation in the relative positions between the hasp and electrical assembly can provide improved operation, ease of install, and/or reduce expense for accommodating tight tolerances.

Referring still to FIG. 16, the electrical assembly 280 illustratively includes a carriage assembly 290 for selective engagement with the electronic lock assembly for electrical engagement via the hasp 224. The carriage assembly 290 includes carriage 292 slidably arranged within the housing 264. The carriage 292 includes a terminal opening 293 defined therethrough for receiving the terminal housing 288 extending through the terminal opening 293 with arrangement for engagement with the hasp 224 as discussed in additional detail herein. The terminal opening 293 is adapted to allow limited movement of the terminal housing 288 within one or more dimensions to encourage engagement with the hasp 224 while providing some functional boundary limitations.

The carriage 292 is illustratively mounted on rails 294 extending longitudinally within the internal cavity 268 of the housing 264 to connect with interior walls of the housing 264. The carriage 292 is supported for sliding movement, longitudinally within the cavity 268 (along the x-direction as indicated in the orientation shown in FIG. 15) along the rails 294 which penetrate through opposite (vertical) ends of the carriage 292 providing linear guidance between distal and proximal positions relative to the door frame.

The carriage assembly 290 illustratively includes a biasing assembly 295 arranged to bias the carriage 292. In the illustrative embodiment, the biasing assembly 295 longitudinally biases the carriage 292 towards the storage door 214 (along x-direction in the orientation of FIG. 15, rightward) towards a default proximal position, illustratively towards the hasp opening 271. The biasing assembly 295 illustratively includes a spring 296 and an arm 298 engaged with the spring to bias the arm 298 to drive the carriage 292 towards the default position.

In the illustrative embodiment, the arm 298 is engaged at a distal end with a wall 300 of the housing 264 and is biased to articulate by the spring 296 towards an extended position pressing the carriage away from the wall 300 towards the default position. The spring tension can be light enough to allow the carriage 292 to slide appropriately to encourage appropriate engagement between the terminal housing 288 and the hasp 224 for electrical engagement, including under magnetic attraction as discussed in additional detail herein.

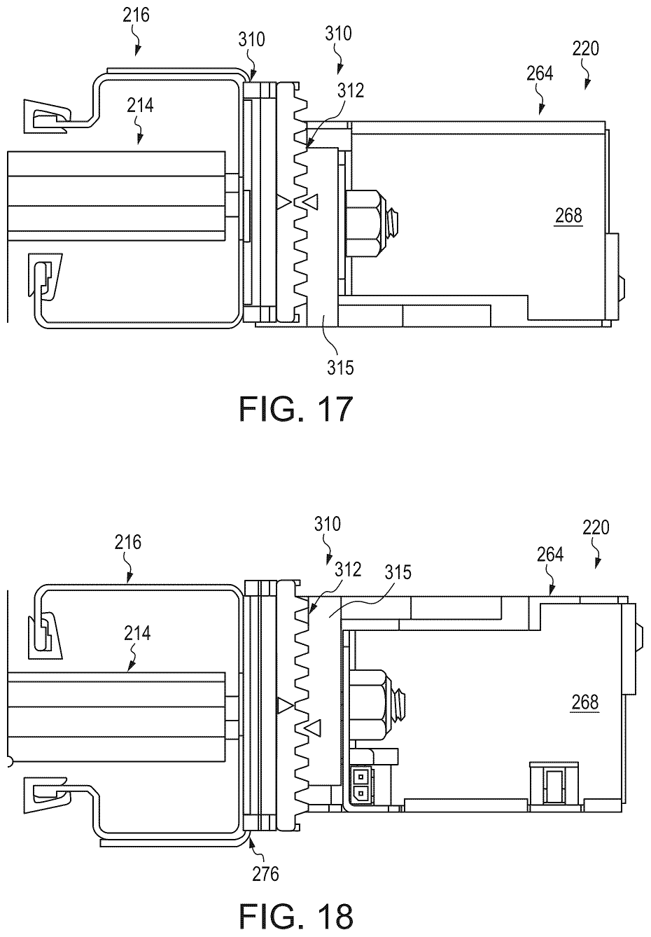

Referring to FIGS. 17 and 18, the catch housing 264 includes an adjustment assembly 310 for adjustment of the installed position of the catch housing relative to the door frame 216. The storage door 214 can be observed to be engaged with the door frame 216 by insertion within a track of the door frame 216 such that door wheels guide the storage door 214 for opening and closing along the track of the door frame 216. The adjustment assembly 310 illustratively includes a complementary toothed connection 312 arranged between the housing 264 and the mount flange 270 permitting incremental adjustment of their relative positions with respect to each other.

The catch housing 264 illustratively includes a pair of wings 315 each having a face defining a plurality of teeth facing towards the mount flange 270. The connection wings 274 of the mount flange 270 each illustratively include a plurality of complementary teeth defined on a face facing towards the housing 264. The teeth of the wings of each of the housing 264 and mount flange 270 collectively define the toothed connection, and illustratively include equal toothed dimensions such that step-wise incremental relative positioning can be achieved.

For example, in FIG. 17, the top side of the catch assembly 220 is shown with a default position of the toothed connection, whereas in FIG. 18, the bottom side of the catch assembly 220 is shown where the default position of the toothed assembly has been altered by one tooth spacing. Accordingly the position of the housing 264 relative to the mount flange 270 can be adjusted along the vertical direction in the orientation of FIGS. 17 & 18, which corresponds with the direction of passage through the access opening of door frame 216, for example, when entering/exiting through the door frame 216 when the door 214 is open. It can be appreciated that the top and bottom portions of the adjustment assembly 310 will typically have equivalent positions, for example, such that each has the default arrangement or the same deviation from the default arrangement.

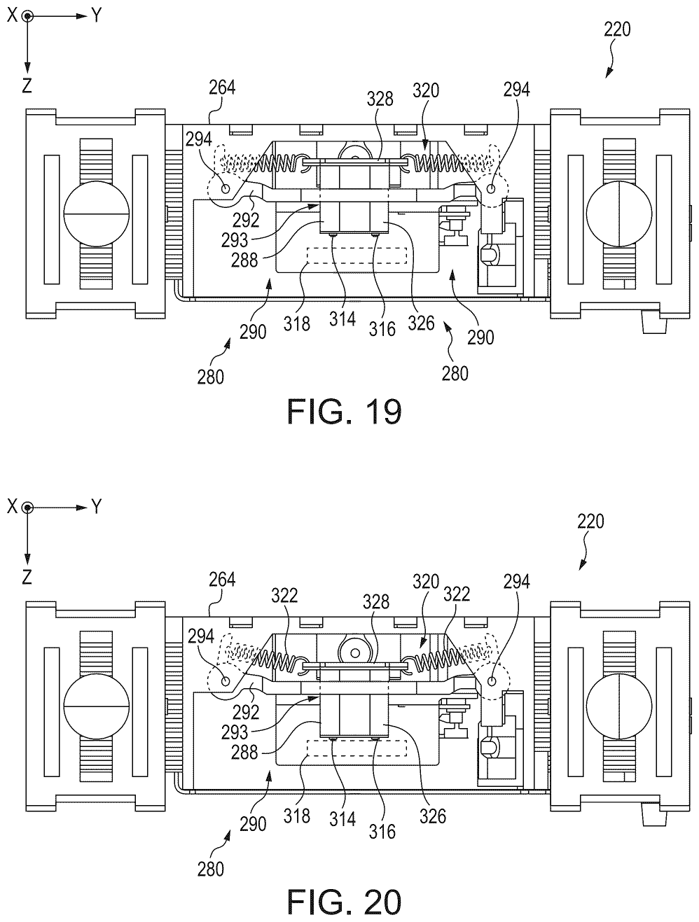

With reference to FIGS. 19 & 20, the terminal housing 288 includes electrical terminals 314, 316. The electrical terminals 314, 316 illustratively correspond with the electrical terminals 282, 284 of the hasp 224 such that electrical engagement between the hasp 224 and the electrical assembly 280 includes engagement between corresponding electrical terminals to communicate electricity. In the illustrative embodiment, such engagement includes physical contact between terminals 282 and 314, and between terminals 284 and 316, as corresponding, although appropriate polarity may include contact between terminals 282 and 316, and between terminals 284 and 314, in some embodiments.

In FIGS. 19 & 20, an exemplary location 318 of the hasp 224 is shown for illustrative purpose indicating the position of the hasp 224 having been placed into the latched position (extended) within the catch housing 264 for engagement with the electrical assembly 280. The carriage assembly 290 illustratively includes a terminal suspension 320 for supporting the terminal housing 288 within the catch housing 264. The terminal suspension 320 can provide resilient support for controlled movement of the terminal housing 288 relative to the carriage 292.

For example, in FIG. 19, the exemplary location 318 of the hasp 224 is shown spaced apart from the terminal housing 288, along the z-direction in the orientation as shown in FIG. 19. This spacing indicates a default position of the terminal housing 288 when the hasp 224 is not within the catch housing 264, and the terminal suspension 320 biases the position of the terminal housing 288 towards the default position. By comparison, in FIG. 20, the terminal housing 288 is moved relative to the default position for engagement with the exemplary location as if the hasp 224 were in the latched position (extended) within the housing 264.

As discussed in additional detail herein, in FIG. 20, the terminal housing 288 has been moved under the force of magnetic attraction with the hasp 224, and thus, the terminal suspension 320 resiliently accommodates such movement so that the terminal housing 288 can engage with the hasp 224 for electrical engagement. In similar manner, although the exemplary location 318 is shown with near perfect alignment to face with the terminals 314, 316 of the terminal housing 288, some misalignment can be accommodated with the terminal suspension 320 whether translationally along or rotationally about one or more of the x, y, or z axes in the orientation as shown in FIGS. 19 & 20, facilitating electrical engagement for wide variety of tolerancing issues between the hasp 224 and the electrical assembly 280. Additionally, such resilient repositioning of the terminal housing 288 via the terminal suspension 320 can be undertake together with the repositioning of the carriage 292 along the rails 294, providing multiple degrees of repositioning to encourage electrical engagement between the hasp 224 and the electrical assembly 280, accommodating many different tolerancing issues of various kinds.

The terminal suspension 320 illustratively includes a number of springs 322 suspending the terminal housing 288 from the carriage 292 within the housing 264. In the illustrative embodiment, the spring 322 are linear springs coupled between the terminal housing 288 and the carriage 292 to provide resilient support. The springs 322 each illustratively couple with opposite sides of the terminal housing 288 along the y direction in FIGS. 19 & 20, on an end of the terminal housing 288 distal from the terminals 314, 316.

In the illustrative embodiment, the terminal housing 288 includes a body 326 having the terminals 314 and 316 protruding therefrom on one side, and a rim 328 formed as a side wall sized larger than the body 326 on another end opposite the terminals 314, 316. The terminal suspension 320 illustrative couples with the rim 328 on a side of the carriage 292 distal from the exemplary location 318 and the body protrudes through the opening 293 to the opposite side of the carriage 292 proximate to the exemplary location 318. The body 326 is illustratively sized to extend through the opening 293 without requiring contact with the carriage 292, however, the rim 328 is sized to abut the carriage 292 when the terminal housing extends too far through the opening 293 to avoid excessive movement, and to permit disengagement between the hasp 224 and the electrical assembly 280 upon withdrawal of the hasp 224 from the catch assembly 220, for example, during unlatching.

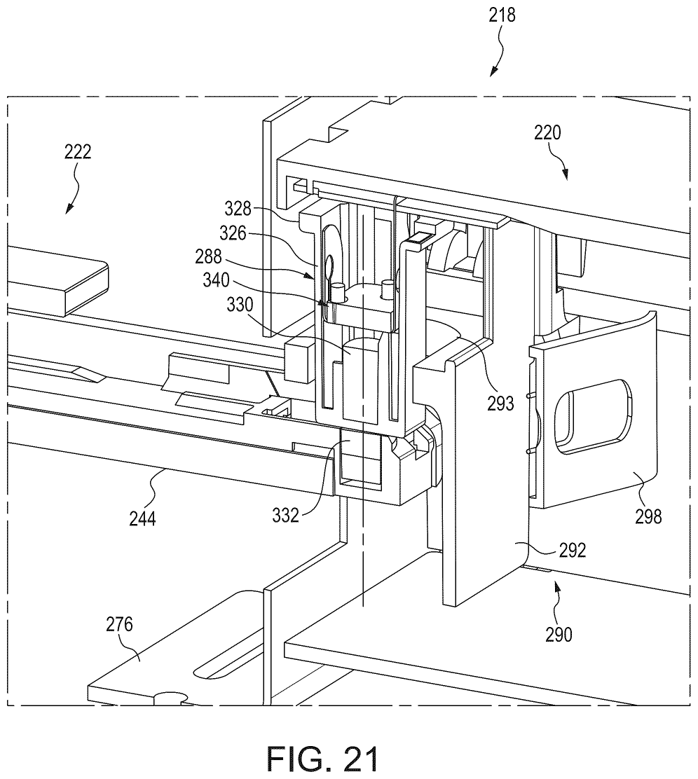

Referring now to FIGS. 21 & 22, engagement between the hasp 224 and terminal housing 288 is shown with cross-section along different directions for ease of disclosure. As mentioned above, the hasp 224 and terminal housing 288 are configured for magnetic attraction with positioning to engage together corresponding terminals 282, 284 and 314, 316. In the illustrative embodiment, the terminal housing 288 includes a magnet 330 and the hasp 224 includes a magnet 332, each arranged with a opposite pole of attraction facing towards the other with the hasp 224 in the latched position (extended) within the housing 264. In some embodiments, the hasp 224 and terminal housing 288 are configured for magnetic attraction with only one including a magnet and the other containing magnetizable material.

In the illustrative embodiment, the magnet 330 of the terminal housing 288 is arranged on a side of the terminal housing 288 proximate to the terminals 282, 284 (and the hasp 224). The magnet 330 is illustratively positioned between the terminals, generally centrally, and otherwise with respect to terminals 314, 316 for correspondence in position with the magnet 332 of the hasp 224 such that when the magnets 330, 332 align with each other under magnetic force of attraction, the terminals 282, 284 and 314, 316 are positioned for engagement with each other for electrical engagement. Similarly, magnet 332 is illustratively positioned between the terminals 282, 284, generally centrally, and otherwise with respect to terminals 282, 284 for correspondence in position with the magnet 330 for alignment of the corresponding terminals 282, 284 and 314, 316 with each other under attraction.

When the hasp 224 is moved towards the latched position (extended) into the catch housing 264 with sufficient proximity with the terminal housing 288 for engagement under magnetic attraction, the carriage 292 can slide and/or the terminal suspension can flex to allow magnetic attraction. Accordingly, the magnetic attraction can assist with resilient positioning, and reliable engagement for electrical engagement.

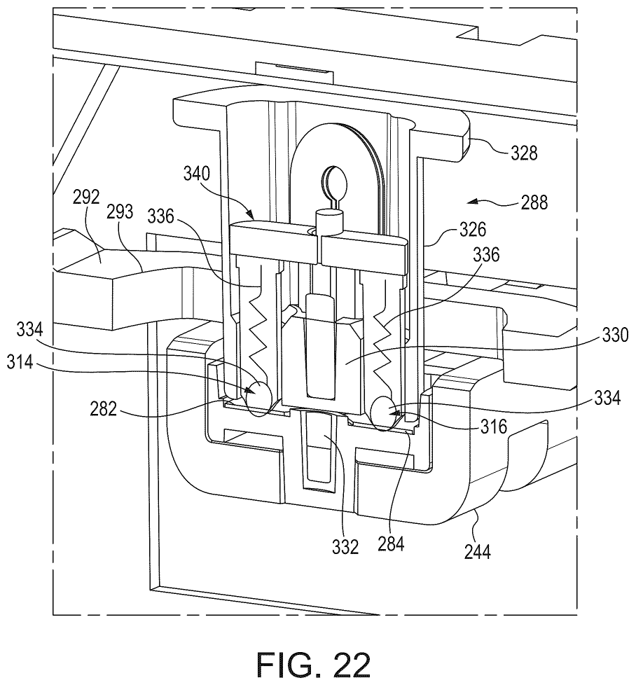

Referring to FIG. 22, in the illustrative embodiment, engagement between the hasp 224 and the terminal housing 288 provides physical contact between the terminals to complete the electric circuit for electrical engagement. In the illustrative embodiment, the electrical terminals 314, 316 of the electrical assembly 280 each include a resilient contact arrangement. The electrical terminals 314, 316 each include a terminal contact 334 and a spring 336 engaged with the corresponding terminal contact 334 to urge the terminal contact 334 outward from the terminal housing 288 and to provide resilient contact with the terminal 282, 284 of the hasp 224. The electrical assembly 280 illustratively includes electrical transmission components 340 extending in electrical communication with the electrical terminals 314,316 to provide electrical communication from an external source.

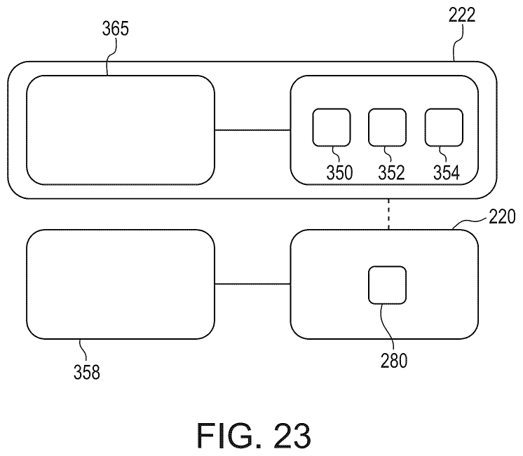

Referring now to FIG. 23, a diagrammatic control arrangement is shown for descriptive purposes. The electronic lock assembly 222 illustratively includes a control system comprising a processor 350, memory 352 storing instructions for execution by the processor 350 to communication commands and/or information for governing operations, and communication circuitry 354 for communicating commands and/information with the processor 350. The electronic lock assembly 222 illustratively includes on-board power storage embodied as a battery 356. The battery 356 can receive power for charging via the electrical engagement between the electronic lock assembly 222. The electronic lock assembly 222 can be arranged in electrical engagement with the catch assembly 220 as disclosed herein, via connection between the hasp 224 and electrical assembly 280, to exchange power and/or data. The catch assembly 220 is illustratively connected with external sources 358 for power and/or data. Such sources 358 can include local power and/or or data networks, but can includes remote systems such as gateways and/or cloud servers in some embodiments. For example, data may include lock information and/or status to other sources from the electronic lock assembly 222, updates and/or communications to the electronic lock assembly 222, and/or other one directional and/or multi-directional communications.

Accordingly, within the present disclosure, devices, systems, and methods for addressing the threshold interface between the storage door 214 and door frame 216 can accommodate electrical connection which can tolerate movement of the storage door, without extension alterations to the door or door frame. The electronic lock assembly 222 can be installed on the storage door 214 for selective electrical engagement with the catch assembly 220 which can be installed on the door frame 216 having hardwired power and/or data. In some embodiments, the catch assembly 220 may be installed on the storage door and the electronic lock assembly 222 may be installed on the door frame, while power and/or data may be communicated in similar manner in either or both directions. In some embodiments, communication circuitry may include wireless communications circuitry.

Within the present disclosure, examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry includes components for facilitating processor operations, for example, suitable components may include transmitters, receivers, modulators, demodulators, filters, modems, analog/digital (AD or DA) converters, diodes, switches, operational amplifiers, and/or integrated circuits.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration only, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media which may be read and executed by one or more processors. A machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided in sub-modules, sub-processes or other units of computer code or data as may be required by a particular design or implementation of the computing device.

In the drawings, specific arrangements or orderings of elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

We claim:

1. A secure access assembly, comprising:
a storage door assembly including a storage door and a door frame, the storage door arranged movable relative to the door frame between a closed position blocking access through the door frame and an open position allowing access through the door frame;
a catch assembly for selective engagement to block opening of the storage door, the catch assembly including a catch receiver of the door frame, a catch housing configured for coupling with the door frame, and an electrical assembly for electrical engagement to communicate electrical power, the electrical assembly arranged within the catch housing, wherein the catch receiver includes a lock opening defined by the door frame for locking engagement; and
an electronic lock assembly comprising:
a latch assembly configured for coupling with the storage door, the latch assembly including a latch housing and a hasp arranged at least partly within the latch housing, the hasp being movable relative to latch housing between an latched position extended from the latch housing to engage with the catch assembly to block against movement of the storage door out from the closed position and a unlatched position retracted relative to the latch housing to disengage with the catch assembly to allow movement of the storage door between the closed and open positions,
wherein, in the latched position, the hasp is configured for engagement within the catch receiver to establish locking engagement, and configured for electrical engagement with the electrical assembly for electrical communication.

2. The secure access assembly of claim 1, wherein the hasp and the electrical assembly of the catch assembly each include at least one electrical terminal configured for engagement with one another for electrical communication.

3. The secure access assembly of claim 1, wherein electrical engagement between the electronic lock assembly and the electrical assembly includes configuration to provide electrical power to the electronic lock assembly coupled with the storage door.

4. The secure access assembly of claim 3, wherein electrical engagement between the electronic lock assembly and the electrical assembly includes configuration to provide electrical power to a battery storage system of the electronic lock assembly.

5. The secure access assembly of claim 1, wherein electrical engagement between the electronic lock assembly and the electrical assembly includes configuration to communicate electrical signals.

6. The secure access assembly of claim 1, wherein electrical engagement between the electronic lock assembly and the electrical assembly includes configuration to communicate electrical power including Power over Ethernet with the electronic lock assembly.

7. The secure access assembly of claim 1, wherein the catch assembly includes an adjustment assembly for adjustment of an installed position of the catch housing relative to the door frame in at least one direction.

8. The secure access assembly of claim 7, wherein the catch housing includes a base coupled with a mount flange, the mount flange configured for securing with the door frame, wherein the adjustment assembly includes complimentary toothed connection between the base and mount flange.

9. The secure access assembly of claim 7, wherein the complementary toothed connection is configured to provide complimentary coupling between the base and mount flange selectively between a number of fixed positions as the installed position along a first direction.

10. The secure access assembly of claim 7, wherein the first direction is arranged along a direction of passage through an access opening of the door frame through which a user can access when the storage door is open.

11. The secure access assembly of claim 1, wherein the electrical assembly of the catch assembly includes a carriage assembly for selective engagement with the electronic lock assembly for electrical engagement.

12. The secure access assembly of claim 11, wherein the carriage assembly includes at least one electrical terminal adapted for movement relative to the catch housing in at least one direction for selective engagement with the hasp for electrical engagement.

13. The secure access assembly of claim 12, wherein the carriage assembly includes a terminal housing having the at least one electrical terminal mounted therein.

14. The secure access assembly of claim 13, wherein the at least one electrical terminal of the terminal housing is resiliently mounted within the terminal housing configured for resilient movement along a longitudinal direction of the terminal housing to promote resilient engagement between the at least one electrical terminal of the carriage assembly and at least one electrical terminal of the hasp.

15. The secure access assembly of claim 14, wherein the at least one electrical terminal is mounted with a spring resiliently biasing the at least one electrical terminal outward from the terminal housing.

16. The secure access assembly of claim 13, wherein the terminal housing is supported within the catch housing by a terminal suspension allowing controlled relative movement of the terminal housing to accommodate compliant engagement within the hasp.

17. The secure access assembly of claim 16, wherein the terminal suspension includes a least one resilient suspension member coupled between the terminal housing and a carriage of the carriage assembly mounted within the catch housing, to resiliently support the terminal housing within the catch assembly.

18. The secure access assembly of claim 17, wherein the terminal housing is arranged resiliently suspended within the catch housing for controlled relative movement to accommodate compliant engagement within the hasp.

19. The secure access assembly of claim 18, wherein, in a default position, the terminal housing is arranged with the at least one terminal spaced apart laterally from the location of the hasp in the latched position.

20. The secure access assembly of claim 19, wherein a magnetic member is arranged within at least one of the hasp and the terminal housing to magnetically encourage physical contact between the at least one electrical terminal of the carriage assembly and the at least one electrical terminal of the hasp.

21. The secure access assembly of claim 20, wherein the magnetic member is arranged to magnetically attract the terminal housing from the default position towards the hasp to close electrical connection in the latched positon of the hasp.

22. The secure access assembly of claim 11, wherein the carriage assembly includes a carriage slidably arranged within the catch housing between a distal position away from the storage door frame and a proximal position proximate to the door frame.

23. The secure access assembly of claim 22, wherein the carriage assembly includes a number of rails mounted within the catch housing and the carriage is slidably mounted on the number of rails for sliding between the distal and proximal positions.

24. The secure access assembly of claim 23, wherein the carriage assembly includes a biasing assembly arranged to bias the carriage towards a default carriage position.

25. The secure access assembly of claim 24, wherein the default carriage position is the proximal position.

26. The secure access assembly of claim 24, wherein the biasing assembly includes a spring arranged between the catch housing and the carriage bias the carriage towards the default carriage position.

27. The secure access assembly of claim 26, wherein the biasing assembly includes an arm extending between the carriage and the catch housing, the arm biased by the spring into a default arm position to encourage the carriage towards the default carriage position.

28. The secure access assembly of claim 1, wherein the storage door is a rollup door.

29. The secure access assembly of claim 1, wherein the lock opening is configured to contact the hasp arranged in the latched position under movement of the storage door out from the closed position to block opening.

30. A secure access lock assembly, comprising:
a catch assembly for selective engagement across a storage door-door frame threshold, the catch assembly including a catch housing, and an electrical assembly for electrical engagement for electrical communication; and
an electronic lock assembly comprising:
a latch assembly including a latch housing and a hasp arranged at least partly within the latch housing, the hasp being movable relative to latch housing between an latched position extended from the latch housing to engage with the catch assembly and associated with blocking against storage door movement relative to the storage door-door frame threshold and a unlatched position retracted relative to the latch housing to disengage with the catch assembly and associated with allowing movement relative to the storage door-door frame threshold,
wherein, in the latched position, the hasp is configured for engagement within the catch housing of the catch assembly for electrical engagement between the electronic lock assembly and the electronic assembly for electrical communication.
